(19) United States
(12) Patent Application Publication
(10) Pub. No.: US 2009/0063405 A1
(43) Pub. Date: Mar. 5, 2009

(54) Method for Providing Information Using Data Communication Network

(76) Inventors: Han-gu Kang, Gyeong-do (KR); Gwang-Sik Kim, Seoul (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 11/666,033

(22) PCT Filed: Oct. 21, 2005
(86) PCT No.: PCT/KR05/03529

§ 371 Date: Apr. 14, 2008

(30) Foreign Application Priority Data
Oct. 21, 2004 (KR) 10-2004-0084575

(51) Int. Cl. G06F 17/30

(52) U.S. Cl. 707/3; 707/E17.108

(57) ABSTRACT

The present invention provides a method of providing information using a data communication network. The information provision method supports an information search using a general public index composed of numerals, characters or period based on information about a person or a business, which is to be searched for, and a personally set index composed of numerals, characters or period preferred by a searcher. Accordingly, the present invention is advantageous in that a searcher can more easily and conveniently search for desired information, and be provided with the information, and in that an integrated search system used for both wired and wireless data communication networks can be constructed.

### TECHNICAL FIELD

The present invention relates, in general, to a method of providing information using a data communication network and, more particularly, to a method of providing information using a data communication network, which supports an index system, allowing a searcher to easily use the index system, when the searcher searches for information about a person or a business that is provided through a wired or wireless data communication network, thus enabling the searcher to be more conveniently provided with information.

### BACKGROUND ART

Recently, as a wired or wireless data communication network has been rapidly popularized, the necessity to search for information about a person or a business through a data communication network, and being provided with the information, has gradually increased. In particular, most modern people own one or more mobile terminals (a mobile phone, a Personal Digital Assistant [PDA] phone, etc.), and the functionality of such a mobile terminal is rapidly developing, so that various information, such as various types of document files or media files, can be easily downloaded through a wireless data communication network, in addition to the execution of a simple call function or data storage function. Therefore, the environment of a wireless data communication network using mobile terminals has been rapidly constructed in such a way that various public institutions or Internet service providers construct separate mobile homepages.

In such a high-speed data communication network environment, a method of more conveniently searching for and providing information about a person or a business is urgently required, but conventional methods have many inconveniences from the point of view of searchers.

For example, Korean Laid-open Publication No. 2000-30826 entitled “Internet search system and method thereof”, which is one method of providing information through a wired communication network, is described. The patent is constructed to systematically search for various types of information by classifying various information related to government, politics, economic, culture, art, tourism, leisure, education, music, medical treatment, history, the press, TV, shopping, the movies, businesses, religion or real estate, according to country, area or field, and by first selecting a field and subsequently selecting a country and an area, or by first selecting a country and an area and subsequently selecting a field. Further, the patent provides an electronic map for each country as an interface tool for a search. However, such a search method is problematic in that it can access information desired by a searcher only in stages using the electronic map, so that not only is considerable time required for a search, but also only governments or organizations having web sites can be found.

Meanwhile, in order to search for information using a wireless communication network, a mobile terminal user can access a phone page provided by a corresponding communication service provider and search for information in stages while moving among provided search menu items, or can move to a page, to which a URL can be directly input, directly input the Uniform Resource Locator (URL) of a web site, composed of English characters, etc., and access the corresponding web site. However, even though the method is used, the inevitable inconvenience using several stages to search menu items still remains to search for desired information, and there are many restrictions imposed on a searcher personally entering a URL composed of characters because the keypad of a mobile terminal is basically implemented to have an input means for numerals, not characters.

Accordingly, a numeric domain name system for enabling access to a corresponding web site merely by entering a unique number, which is obtained by converting an English domain name into numerals, has recently been devised. However, such a system is problematic in that, since an actual mobile phone user must remember two different versions (English and numeral) of domain names, it is inconvenient to use, and since a plurality of English domain names, using the same numerals, exists, competition occurs between a great number of Internet service providers, and a service provider who is not registered encounters considerable difficulty in conducting business.

Moreover, a method of providing an integrated search system using wired and wireless data communication networks has not been developed yet.

### DISCLOSURE

### Technical Problem

Accordingly, the present invention has been made keeping in mind the above problems, and an object of the present invention is to provide a method of providing information using a data communication network, which supports an index system that can be easily used in both wired and wireless data communication networks using numerals, characters or period, thus allowing a searcher to more conveniently access and search for desired information.

Another object of the present invention is to provide a method of providing information using a data communication network, which enables desired information to be searched for using the index system, and to be directly provided by an information provider terminal, so that wired/wireless Internet connection is easily conducted, thus improving a search speed, and eliminating the inconvenience of registering a separate domain for wired/wireless Internet connection or of constructing a separate phone page for mobile access.

### Technical Solution

In order to accomplish the above objects, the present invention provides a method of providing information using a data communication network, comprising the steps of (a) a service provision server receiving a unique index request signal, which is required to register a unique general public index for information about a person or a business, from an information provider terminal; (b) the service provision server assigning a general public index composed of numerals, characters or period, based on information about a corresponding person or business when receiving the unique index request signal from the information provider terminal, and storing the general public index; (c) the service provision server recognizing a connection of a search terminal through a wired or wireless data communication network; and (d) the service provision server receiving a search index, input from the searcher terminal, searching previously stored general public indices, and providing information about a person or a business, registered as a general public index corresponding to the search index, to the searcher terminal.

Preferably, step (b) may further comprise the steps of (b-1) the service provision server requesting information, to which an index is to be assigned, from the information provider terminal, having requested registration of the general public index, and storing requested information in a member information DB; (b-2) the service provision server assigning an area index that is composed of numerals, characters or period and is preset based on the stored information, and storing the area index in a general index DB; (b-3) the service provision server assigning a sub-area index that is composed of numerals, characters or period and is preset based on the stored information, and storing the sub-area index in the general index DB; (b-4) the service provision server assigning an entrepreneur classification index that is composed of numerals, characters or period and is preset based on the stored information, and storing the entrepreneur classification index in the general index DB; and (b-5) the service provision server assigning to the corresponding business or person a business category index that is composed of numerals, characters or period and is preset based on the stored information, and storing the business category index in the general index DB, wherein the search index is information received through a URL input window of an Internet browser used in the searcher terminal, or through a search field provided by a site operated by the service provision server, and includes at least one of the area index, the sub-area index, the entrepreneur classification index and the business category index.

Preferably, step (b) may further comprise the steps of (b-6) the service provision server determining whether a request for registration of a one-link index has been received from the corresponding information provider terminal; and (b-7) if a request for registration of a one-link index has been received, the service provision server assigning a one-link index composed of numerals, characters or period, and storing the one-link index in the general public index DB; wherein the search index includes at least one of the area index, the sub-area index, the entrepreneur classification index, the business category index and the one-link index.

Preferably, step (b) may further comprise, before step (b-2), the step of the service provision server assigning a country index that is composed of numerals, characters or period and is preset based on the stored information, and storing the country index in the general index DB; wherein the search index includes at least one of the country index, the area index, the sub-area index, the entrepreneur classification index, the business category index, and the one-link index.

Preferably, step (d) may comprise the steps of (d-1) if, as a result of the search of the general index DB by the service provision server, it is determined that a general public index identical to the search index exists, providing information about a person or a business, registered as the corresponding general public index, to the searcher terminal; and (d-2) if, as a result of the search of the general index DB by the service provision server, it is determined that no general public index identical to the search index exists, providing a list of persons or businesses corresponding to the search index to the searcher terminal, and then providing information about a person or a business, selected by a searcher from the list, to the searcher terminal.

Meanwhile, even when a searcher is a mobile terminal user, and searches for information through a wireless data communication network, the searcher can be more conveniently provided with information about a desired person or business through steps (b-1) to (b-7). However, in the case of a mobile terminal, since a URL input window does not exist in an Internet browser, the mobile terminal is constructed to input at least one of a country index, an area index, a sub-area index, an entrepreneur classification index, a business category index and a one-link index through a separate search field. A detailed description thereof will be provided later.

According to the present invention, when the searcher uses a mobile terminal, a search function using a personally set index is additionally supported, thus enabling information to be more conveniently searched for. For this operation, step (c) may comprise the step of (c-1) the service provision server receiving a unique index request signal, which is required to register a personally set index for the searcher terminal, from the searcher terminal, registering a personally set index composed of numerals, characters or period for information about a person or a business, which is preferred by a corresponding searcher, and storing the personally set index; and step (d) may comprise the step (d-1) of, if the search index is a personally set index, the service provision server searching previously stored personally set indices, and providing information about a person or a business, registered as a personally set index corresponding to the search index, to the searcher terminal.

Meanwhile, the personally set index may include a one-key index for direct connection and a one-key index for bookmarks, and step (c-1) may comprise, in order to provide a search function using respective one-key indices, the steps of (c-1-1) the service provision server requesting information about a desired person or business to which to be directly connected from the searcher terminal, having requested the personally set index, and receiving at least one piece of information from the searcher terminal; (c-1-2) the service provision server requesting the one-key index for direct connection, composed of numerals, characters or period, to information about the desired person or business to which to be directly connected, setting the information about the person or business in connection with the received one-key index for direct connection, and storing the one-key index in a personal index DB; (c-1-3) the service provision server requesting information about a desired person or business to be set as a personal bookmark from the searcher terminal, having requested the personally set index, and receiving at least one piece of information from the searcher terminal; and (c-1-4) the service provision server displaying the one-link index for bookmarks, composed of numerals, characters or period, to directly access the personal bookmark, setting information about a desired person or business to a personal bookmark of the corresponding searcher terminal, and storing the personal bookmark in the personal index DB.

Preferably, step (d-1) may comprises the steps of (d-1-1) the service provision server providing a search field to the searcher terminal that is accessed for connection to the personally set index, and receiving an input search index; (d-1-2) the service provision server searching the personal index DB using the received search index; (d-1-3) if, as a result of the search of the personal index DB by the service provision server, the search index is a preset one-key index for direct connection, providing information about a person or a business, set in connection with the one-key index, to the searcher terminal; and (d-1-4) if, as a result of the search of the personal index DB by the service provision server, the search index is a one-key index for bookmarks, providing a list of information about persons or businesses, set as a corresponding bookmark, to the searcher terminal and providing information about a person or a business selected by the searcher to the searcher terminal.

Preferably, in order for the service provision server to determine whether access by the searcher terminal corresponds to a connection to a general public index, or to connection to a personally set index at step (c), a method may be selected from a group consisting of a method of separately providing a hotkey for connection to the general public index and a hotkey for connection to the personally set index on the searcher terminal, and allowing the service provision server to receive different access signals for respective hotkeys, thus performing determination; a method of providing a single hotkey on the searcher terminal, pressing the hotkey after entering a number code specified according to connection purpose, and allowing the service provision server to receive different access signals for respective input number codes, thus performing determination; a method of providing a single hotkey on the searcher terminal, varying the number of times that a searcher presses the hotkey depending on connection purpose, and allowing the service provision server to receive different access signals depending on the number of pressing times, thus performing determination; a method of providing a single hotkey on the searcher terminal and forcing selection of a menu item for each connection purpose after the searcher terminal has accessed the service provision server, thus performing determination; a method of providing a separate service menu item for accessing the service provision server, instead of providing a separate hotkey on the searcher terminal, and forcing selection of a separate menu item for each connection purpose after the searcher terminal has accessed the service provision server, thus performing determination; and a method of registering a wireless Content Provider (CP) menu item for accessing the service provision server as a lower level menu item on the wireless Internet of a service provider, to which the corresponding searcher terminal belongs, instead of providing a separate hotkey on the searcher terminal, and forcing selection of a separate menu item for each connection purpose after the searcher terminal has accessed the service provision server, thus performing determination.

### DESCRIPTION OF DRAWINGS

FIG. 1 is a diagram showing the construction of a data communication system according to the present invention;

FIG. 2 is a block diagram showing the construction of a service provision server according to the present invention;

FIG. 3 is a view showing an example of a searcher terminal according to the present invention;

FIG. 4 is a view showing an example of a method of inputting a search index according to the present invention;

FIG. 5 is a flowchart showing the basic construction of a method of providing information according to the present invention;

FIG. 6 is a flowchart showing the procedure of registering a general public index according to the present invention;

FIG. 7 is a flowchart of a search procedure using a general public index according to the present invention;

FIG. 8 is a flowchart showing the overall scheme of a method using a personally set index according to the present invention;

FIG. 9 is a flowchart of the procedure of registering a personally set index according to the present invention; and

FIG. 10 is a flowchart of a search procedure using a personally set index according to the present invention.

### DESCRIPTION OF REFERENCE CHARACTERS OF IMPORTANT PARTS

100: data communication network 200: service provision server
300: information provider terminal 400: searcher terminal

### BEST MODE

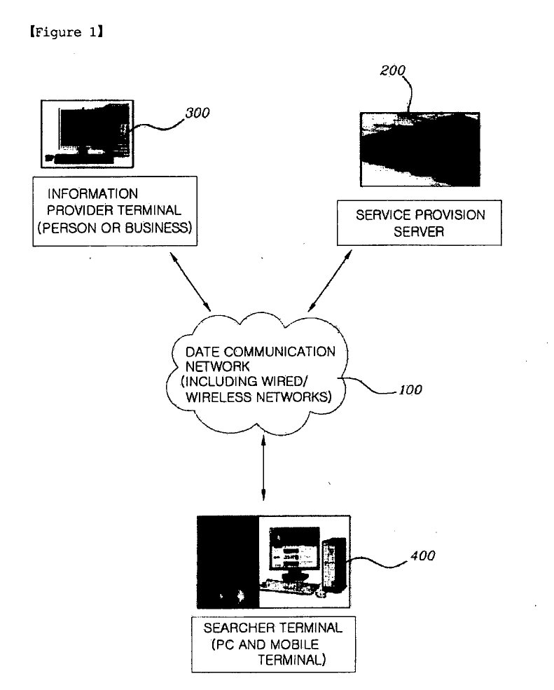

Hereinafter, embodiments of the present invention will be described in detail with reference to the attached drawings. FIGS. 1 to 3 illustrate a data communication system to which the present invention is applied.

As shown in FIG. 1, the data communication system to which the present invention is applied includes a data communication network 100, a service provision server 200, an information provider terminal 300 and a searcher terminal 400.

The data communication network 100 includes the Internet, using both a Transmission Control Protocol/Internet Protocol (TCP/IP) enabling wired connection and a Wireless Application Protocol (WAP) enabling wireless connection.

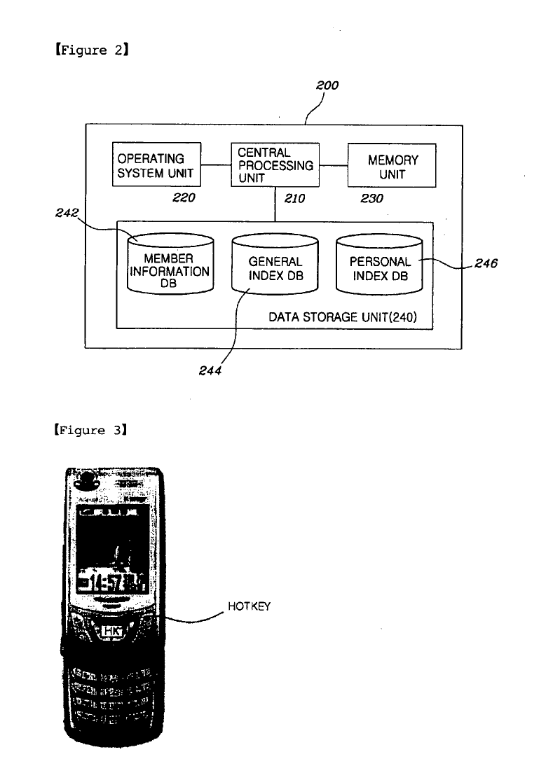

The service provision server 200 functions to allow the information provider terminal 300 to access the service provision server through the data communication network 100 and to be assigned a unique index for information, which the information provider terminal 300 desires to provide, and functions to allow the searcher terminal 400 to conduct a search using the corresponding index and to be provided with information set in connection with the index. For this operation, as shown in FIG. 2, the service provision server 200 includes a Central Processing Unit (CPU) 210, an operating system unit 220, a memory unit 230, including Read Only Memory (ROM) and Random Access Memory (RAM), and a data storage unit 240. Although not shown in the drawing, the service provision server 200 may include a separate display unit.

The CPU 210 must perform the function of executing a number of mathematical calculations, required for large-size task processing and mutual information exchange, and searching a database. Preferably, the CPU 210 may be a processor having a class equal to or higher than that of Intel's 100 MHz P54C, Motorola's 120 MHz power PC604, or Sun Microsystems's 166 MHz ultra SPARC-1 series. Meanwhile, a separate Operating System (O/S) necessary for driving the CPU is stored in the operating system unit 220.

The memory unit 230 functions to temporarily store data according to the present invention, and may be any memory, such as Electrically Erasable Programmable Read Only Memory (EEPROM), Dynamic RAM (DRAM) or Static RAM (SRAM) having a size of 128 MB or above.

The data storage unit 240 includes a member information DB 242, a general index DB 244, and a personal index DB 246, and generates and manages the above DBs using a database management program, such as data software manufactured by Oracle.

The member information DB 242 stores basic member information related to public relations or advertisements of personal or business members that gain access through the information provider terminal 300 so as to be assigned a general public index provided by the service provision server 200, and also stores basic member information of a searcher who desires to register a personally set index provided by the service provision server 200 when the searcher uses a mobile terminal.

In this case, the basic member information of a person or a business, desiring to be assigned a general public index, may be information, such as a member ID, a password, a business name, a country name, an area name, a business registration number, the name, resident registration number and address of a representative, entrepreneur classification, business category, the existence of a homepage, homepage URL when the home page exists, the number of employees, or other information necessary for publicizing persons or businesses, but the present invention is not limited to the above information.

Further, the basic member information of a mobile terminal user, desiring to register a personally set index, may be a user ID, a password, a user name, an address, communication service provider classification, the phone number of a mobile terminal, the unique recognition code of a mobile terminal, etc., but the present invention is not limited to the above information.

The general index DB 244 stores therein a general public index assigned to the personal or business member, and business information related to the general public index. The general public index is composed of numerals, characters or period, and includes a country index, an area index, a sub-area index, an entrepreneur classification index, a business category index, and a one-link index. A detailed description thereof will be provided later.

The personal index DB 246 stores therein a personally set index, separately set by each mobile terminal user depending on his or her preferences. This personally set index includes a one-key index for direct connection that enables direct connection to desired information, and a one-key index for bookmarks that manages desired information in the form of a list. A detailed description thereof will be provided later.

The information provider terminal 300 is used by a person or a business who wants to provide information thereof through the data communication network 100. The corresponding person or business accesses the service provision server 200 through the data communication network 100, is assigned a unique general index composed of numerals, characters or period depending on the person's site information or the business's characteristics, and registers the unique general index, thus allowing searchers to easily search for information provided by the person or business through the service provision server 200.

For this operation, the information provider terminal 300, which is a computer device enabling communication, must have an Internet browser capable of displaying web content, and may include a personal computer, such as a desktop computer or notebook computer, a wired phone, or a mobile phone or Personal Digital Assistant (PDA) capable of performing wireless Internet communication, in addition to a business server. Therefore, the information provider terminal 300 is not limited to that of an entrepreneur who actually operates a specific business, but can be a personal client who operates a typical personal web site, such as a personal homepage or mini-homepage. Further, the person or business, using the information provider terminal 300, does not necessarily need to operate a web site thereof, and can operate to store simple information, such as the introduction of a business, in the terminal thereof or in the service provision server 200, and then directly transmit the simple information when a search is requested.

The searcher terminal 400 accesses the service provision server 200 through the data communication network 100 and inputs a general public index or personally set index corresponding to required information, thus easily obtaining corresponding information. The searcher terminal 400 may include both a wired terminal and a mobile terminal capable of transmitting or receiving characters, images, moving images or audio data through wired/wireless communication. Any terminal, such as a PDA, a Handheld Personal Computer (HPC), a Web pad, a smart phone, a Wireless Application Protocol (WAP) phone, a palm PC, an e-book terminal or a Hand Held Terminal (HHT), as well as a desktop computer or notebook computer, is comprised in the definition of “searcher terminal” 400.

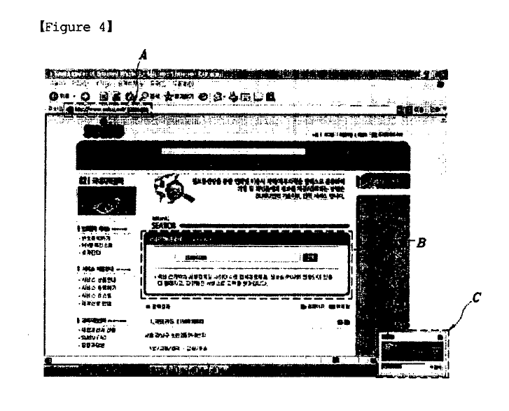

If the searcher terminal 400 is a mobile terminal, the searcher terminal 400 may be preferably provided with a hotkey (HK) so as to directly access the service provision server 200 through a wireless data communication network, as shown in FIG. 3. In this case, the searcher presses the hotkey (HK), which is not a conventional hotkey linked to a phone page and provided by a communication service provider, at the time of starting the wireless Internet, thus enabling the searcher terminal 400 to immediately access a search page provided by the service provision server 200.

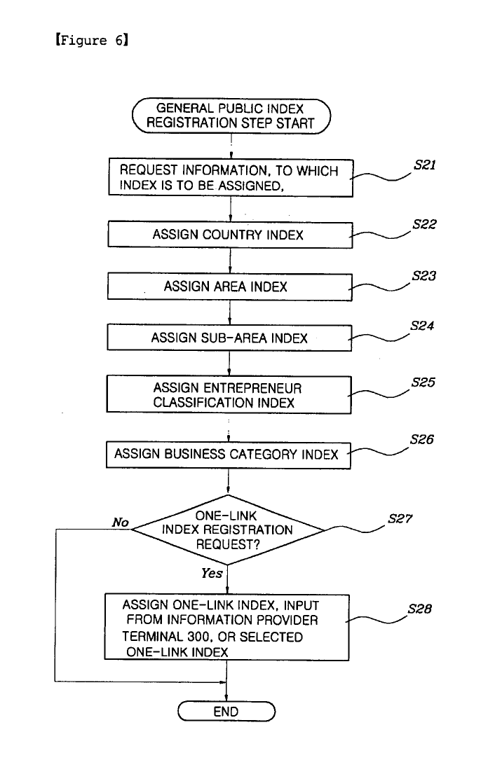

FIG. 5 is a flowchart showing the basic construction of a method of providing information using a data communication network according to the present invention.

The service provision server 200 receives a request signal required for the information provider terminal 300 to be assigned a general public index for information thereof, from the information provider terminal 300 connected thereto through the data communication network 100 at step S10. In this case, the general public index is a unique index composed of numerals, characters or period, and assigned to a person or a business for information thereof by the service provision server 200. A searcher can search for and be provided with information about a person or a business through the systematically set general public index.

When receiving the request signal for a general public index from the information provider terminal 300, the service provision server 200 requests information about a person or a business, to which a general public index is to be assigned, from the person or the business, stores received information about the person or business in the member information DB 242, assigns a general public index which is composed of numerals, characters or period and preset based on the person or business information, and stores the general public index in the general index DB 244 at step S20.

The preset numerals, characters or period, which are the basis for assigning a general public index, are systematically classified according to the country, area, sub-area, or entrepreneur classification and business category of a person or a business. According to the circumstances, a one-link index, set by an information provider, can be assigned as a general public index, regardless of country, area, sub-area, entrepreneur classification or business category characteristics.

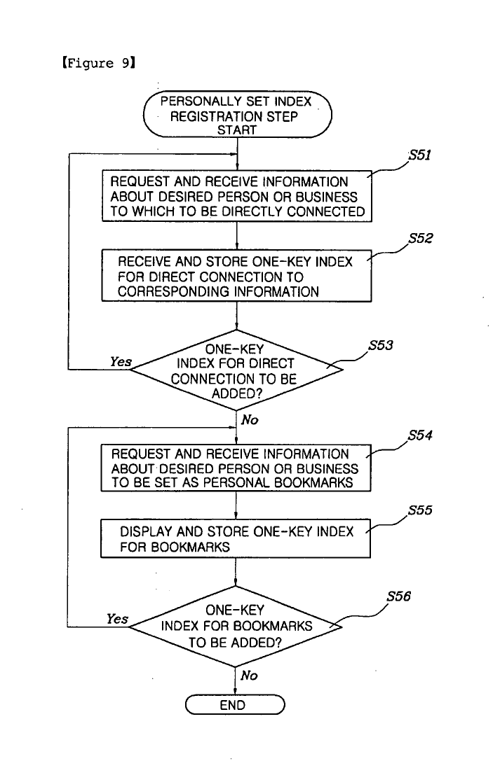

After the service provision server 200 has requested the general public index for information about the person or business from the information provider terminal 300 and has assigned the general public index, the service provision server 200 recognizes the connection of the searcher terminal 400 through the data communication network 100 at step S30. In this case, the searcher terminal 400 may be a wired terminal, such as a desktop computer connected through a wired data communication network, or a wireless terminal, such as a mobile phone or PDA phone connected through a wireless data communication network. If the searcher terminal 400 is a mobile terminal, the present invention additionally supports a search function using a personally set index, which will be described in detail later with reference to FIGS. 8 to 10.

When recognizing the connection of the searcher terminal 400, the service provision server 200 receives a search index from the searcher terminal 400 and stores the search index in the memory unit 230. Thereafter, the service provision server 200 searches the general index DB 244 and provides information about a person or a business that is registered in connection with a general public index corresponding to the search index to the searcher terminal 400 at step S40. As a method of providing information about a person or a business, there is a method of directly transmitting information stored in the service provision server 200 or the information provider terminal 300 to the searcher terminal 400, or a method of supporting the connection of the searcher terminal 400 to a web site operated by the person or business.

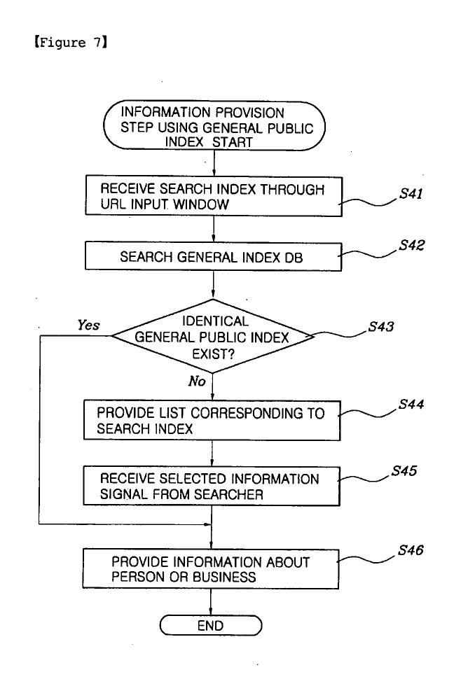

A procedure of registering a general public index at step S20 according to the present invention is described in detail with reference to FIG. 6.

First, the service provision server 200 requests information about a person or a business, to which a general public index is to be assigned, from the information provider terminal 300, and stores received information about the person or business in the member information DB 242 at step S21.

In this case, the person or business information includes information, such as the business name, country name, area name and business registration number of an enterprise actually running a specific business, the name, resident registration number and address of a representative, entrepreneur classification, business category, existence of a homepage, a URL when a homepage exists, the number of employees, information indicating whether to assign a one-link index, or information necessary for public relations, as well as a personal web site, such as a personal homepage or mini-home page, as described above.

The service provision server 200 assigns to a corresponding person or business a country index, which is composed of numerals, characters or period and is preset by an operator, based on the name of a country, to which the person or business stored in the member information DB at step S21 belongs, and stores the country index in the general index DB 244 at step S22. The country index can be configured using a country phone code (Korea: 082, Japan: 081, China: 086, etc.), so that a system capable of systematically searching for information in the whole world can be constructed using the country index. The country index is the highest level index of the present invention, but, in the case of a system for providing information about a person or a business within a single country, an index system is constructed by utilizing an area index, which will be described later, as the highest level index. Therefore, step S22 for assigning a country index is not an essential step according to the present invention.

In the embodiment, the country index for each country is described in the following table 1.

TABLE 1

| Country name | Country index |
|---|---|
| U.S. | 001 |
| Korea | 082 |
| Japan | 081 |
| China | 086 |
| Great Britain | 044 |
| Germany | 049 |

The service provision server 200 assigns to a corresponding person or business an area index that is composed of numerals, characters or period and is preset by an operator, based on the name of the area of the person or business, stored in the member information DB at step S21, and stores the area index in the general index DB 244 at step S23.

In this embodiment, a method of assigning an area index is described in detail below.

The service provision server 200 divides the area of a corresponding person or business into Seoul special city, six metropolitan cities, Gyeonggi province, Chungcheongnam/buk province, Jeollanam/buk province, Gyeongsangnam/buk province, Jeju province and Gangwon province, assigns a three-digit direct distance dialing (DDD), allocated to each area other than Seoul, as an area index, assigns an area index of 002 to Seoul, and stores the area indices, which have been assigned to respective persons or businesses, in the general index DB 244.

In this embodiment, area indices for respective areas of Korea are described in the following Table 2.

TABLE 2

| Area name | Area index |
|---|---|
| Seoul special city | 002 |
| Gyeonggi province | 031 |
| Busan metropolitan City | 051 |
| Incheon metropolitan City | 032 |
| Daegu metropolitan City | 053 |
| Daejeon metropolitan City | 042 |
| Gwangju metropolitan City | 065 |
| Ulsan metropolitan City | 052 |
| Jeju province | 064 |
| Chungcheongnam province | 041 |
| Chungcheongbuk province | 043 |
| Gyeongsangnam province | 055 |
| Gyeongsangbuk province | 054 |
| Jeollanam province | 061 |
| Jeollabuk province | 063 |
| Gangwon province | 033 |

Next, the service provision server 200 assigns to a corresponding person or business a sub-area index that is composed of numerals, characters or period and is preset by an operator, based on the name of the area of the person or business, stored in the member information DB 242 at step S21, and stores the sub-area index in the general index DB 244 at step S24.

In this embodiment, a method of assigning a sub-area index is described in detail below.

The service provision server 200 divides Seoul special city into 25 sub-areas, including Gangnam district, Gangdong district, Gangbuk district, Gangseo district, etc., divides Gyeonggi province into 31 sub-areas, including Goyang city, Ilsan district, Gwacheon city, Gwangmyeong city, etc., divides Busan metropolitan city into 16 sub-areas, including Gangseo district, Geunjeong district, Nam district, Dong district, etc., divides Incheon metropolitan city into 10 sub-areas, including Gyeyang district, Nam district, Namdong district, etc., divides Daegu metropolitan city into 8 sub-areas, including Nam district, Dalseo district, Dong district, etc., divides Daegeon metropolitan city into 5 sub-areas, including Daedeok district, Dong district, Yuseong district, etc., divides Gwangju metropolitan city into 5 sub-areas, including Kwangsan district, Nam district, etc., divides Ulsan metropolitan city into 5 sub-areas, including Ulju county, Nam district, Dong district, etc., divides Jeju province into 4 sub-areas, including Seogwipo city, Jeju city, etc., divides Chungcheongnam province into 15 sub-areas, including Gongju city, Nonsan city, Boryeong city, etc., divides Chungcheongbuk province into 11 sub-areas, including Jecheon city, Cheongju city, Chungju city, etc., divides Gyeongsangnam province into 19 sub-areas, including Geoje city, Gimhae city, Milyang city, etc., divides Gyeongsangbuk province into 23 sub-areas, including Gyeongsan city, Gyeongju city, Gumi city, etc., divides Jeollanam province into 22 sub-areas, including Gwangyang city, Naju city, Mokpo city, etc., divides Jeollabuk province into 14 sub-areas, including Gunsan city, Gimje city, Namwon city, etc., divides Gangwon province into 18 sub-areas, including Gangneung city, Donghae city, Samcheok city, etc., additionally assigns a two-digit sub-area index for each sub-area to the area index, and stores the corresponding sub-area index in the general index DB 244.

Of the sub-area indices assigned in this embodiment, sub-area indices for the area of Gyeonggi province are indicated in the following table 3.

TABLE 3

| Sub-area | Sub-area index |
|---|---|
| Goyang city | 00 |
| Ilsan district | 01 |
| Gwacheon city | 02 |
| Gwangmyeong city | 03 |
| Guri city | 04 |
| Gunpo city | 05 |
| Gimpo city | 06 |
| Namyangju city | 07 |
| Dongducheon city | 08 |
| Bucheon (Sosa, Ojeong, Wonmi) | 09 |
| Seongnam Bundang, Sujeong, Jungwon) | 10 |
| Suwon (Gwonseon, Jangan, Paldal) | 11 |
| Siheung city | 12 |
| Ansan city | 13 |
| Anseong city | 14 |
| Anyang city (Dongan, Manan) | 15 |
| Osan city | 16 |
| Yongin city | 17 |
| Uiwang city | 18 |
| Uijeongbu city | 19 |
| Icheon city | 20 |
| Paju city | 21 |
| Pyeongtaek city | 22 |
| Hanam city | 23 |
| Gapyeong county | 24 |
| Kwangju county | 25 |
| Yangju county | 26 |
| Yeoju county | 27 |
| Yeoncheon county | 28 |
| Pocheon county | 29 |
| Hwaseong county | 30 |

Next, the service provision server 200 assigns to a corresponding person or business an entrepreneur classification index that is composed of numerals, characters or period and is preset by an operator, based on the entrepreneur classification of the person or business, stored in the member information DB 242 at step S21, and stores the entrepreneur classification index in the general index DB 244 at step S25.

In this embodiment, in the case of a business operated by a corporate entrepreneur, the service provision server 200 assigns A to the business, in the case of a business operated by an individual entrepreneur, the service provision server 200 assigns B to the business, and in the case of a typical person, not an entrepreneur, the service provision server 200 assigns C to the person.

Next, the service provision server 200 assigns to a corresponding business or person a business category index that is composed of numerals, characters or period and is preset by an operator, based on the business category of each business, stored in the member information DB 242 at step S21, and stores the business category index, assigned to the person or business, in the general index DB 244 at S26.

In this embodiment, the central processing unit 210 of the service provision server 200 divides business categories into 54 detailed categories, assigns a three-digit unique index to each detailed category, additionally assigns a business category index for each category of business, operated by the person or business, to the area index, sub-area index and entrepreneur classification index that are obtained at steps S22 to S25, and stores the business category index in the general index DB 244. Each business category index is indicated in the following Table 4.

TABLE 4

| Index | Category |
|---|---|
| 100 | furniture related business (kitchen, office supplies, agency) |
| 110 | gas related business (production, equipment) |
| 120 | electronic appliance related business (production, sales, |
| | repair) |
| 130 | veterinary hospital |
| 140 | advertisement, planning related business (signboard, adver- |
| | tising media production and sales) |
| 150 | Gallery (art gallery, framing and sales) |
| 160 | construction related business A (single, combined construc- |
| | tion, heavy equipment) |
| 170 | construction related business B (machine tools, materials, |
| | building materials production and sales) |
| 180 | tractor (vehicles, rescue, traction) |
| 190 | wedding related business |
| 200 | lightweight partitioning (fabricated partition production |
| | and construction) |
| 210 | tool related business (production, sales, lease, etc.) |
| 220 | Licensed real estate agent, certified public labor practi- |
| | tioner (real estate related business) |
| 230 | travel related business (travel bureau, recreation facility, |
| | tourist resort, transportation business) |
| 240 | jewelry (production and sales company) |
| 250 | financial business (bank, insurance, safety, security cor- |
| | poration, etc.) |
| 260 | flower shop (whole/retail sales, delivery company) |
| 270 | fishing supplies (production, sales, fishing spot, etc.) |
| 280 | men's clothes (production, sales, specialty store) |
| 290 | cooling/heating related business (construction, sales, pipe |
| | installation, etc.) |
| 300 | Refrigeration and hot water system (spring water sales, |
| | equipment production, sales company) |
| 310 | agriculture related business |
| 320 | diet related business (weight loss, etc.) |
| 330 | organization (financial organization, press, women, reli- |
| | gion, etc.) |
| 340 | public park (national park, general recreation facility, |
| | etc.) |
| 350 | lending related business (tool, book, rent car, video |
| | tape, etc.) |
| 360 | agency related business (gate guard, service, event, |
| | guard, etc.) |
| 370 | mountain-climbing related business (equipment, supplies |
| | production and sales company) |
| 380 | record related business (record, CD, tape production, |
| | sales, etc.) |
| 390 | leisure related business (leisure supplies production, |
| | sales, etc.) |
| 400 | REMICON related business |
| 410 | beauty, cosmetics related business |
| 420 | bathing related business (bath, sauna, fomentation room, |
| | etc.) |
| 430 | stationery related business (production and sales) |
| 440 | timber related business (production, processing, sales, |
| | etc.) |
| 450 | radio communication device (two way radio, mobile communi- |
| | cation device production, sales, etc.) |
| 460 | department store (shopping center, department store, etc.) |
| 470 | venture enterprise |
| 480 | hospital, medical center related business (general, private, |
| | special hospital, etc.) |
| 490 | office machine related business (office machine production, |
| | sales company) |
| 500 | photography related business (photo studio, supplies, |
| | photographic apparatus production, sales company, etc.) |
| 510 | water and sewage related business (equipment, machine |
| | production, sales construction company) |
| 520 | book related business (publication production, sales |
| | company) |
| 530 | gift related business |
| 540 | Laundry related business |
| 550 | marine products related business |
| 560 | Lodging related business (homestay, motel, condominium, |
| | hotel, etc.) |
| 570 | sports related business (center, supplies, hair products |
| | production and sales company) |
| 580 | shoes related business (maker, typical production sales |
| | company) |
| 590 | interior design related business (interior) |
| 600 | Children's clothes related business (infant, child clothes |
| | production and sales) |
| 610 | musical instrument related business (production, sales and |
| | repair) |
| 620 | aluminum sash related business (production, sales and |
| | construction company) |
| 630 | accessory (production and sales, personal ornaments) |
| 640 | glasses related business (production and sales) |
| 650 | angle iron related business (production and sales) |
| 660 | pharmacy related business (production and sales) |
| 670 | toy related business (toy, doll, plaything production |
| | and sales) |
| 680 | motorcycle related business |
| 690 | famous brands |
| 700 | gardening related business (flower, tree, plant, orna- |
| | mental tree growing and sales) |
| 710 | glass related business |
| 720 | food related business (Korean, Japanese, Chinese, packed |
| | lunch specialty store, etc.) |
| 730 | medical instrument related business (production and sales) |
| 740 | moving related business (domestic and foreign packing trans- |
| | portation company) |
| 750 | print related business |
| 760 | Internet related business |
| 770 | rental service related business (furniture, building, |
| | factory, etc.) |
| 780 | vehicle related business (sales, repair, interior, rental |
| | agency, car washing, etc.) |
| 790 | water-purifier tank related business (FRP, repair, process- |
| | ing, production, etc.) |
| 800 | confectionery industry (confectionery, bakery) |
| 810 | landscape architecture related business |
| 820 | lighting apparatus related business (production, sales, |
| | construction company) |
| 830 | used car related business |
| 840 | kitchen utensil related business (equipment, tool produc- |
| | tion and construction company) |
| 850 | oil station related business (oil supply, gas manufactur- |
| | ing, and sales) |
| 860 | physical training facility related business (golf, bil- |
| | liard room, bowling alley, fencing school, etc.) |
| 870 | poultry farming related business |
| 880 | computer related business |
| 890 | delivery, transportation related business |
| 900 | paint related business (production, sales and construction |
| | company) |
| 910 | educational institute related business |
| 920 | service related business |
| 930 | other businesses |

Next, the service provision server 200 determines whether a corresponding information provider terminal 300, having requested the registration of a general public index related to information about a person or a business, has requested the assignment of a one-link index at the time of requesting registration at step S27.

The term “one-link index” means a feature index that is designated by a corresponding person or business and is composed of numerals, characters or period, as described above, is related to the business category of the person or business, is easily remembered by a searcher, and allows the searcher to be provided with information about the person or business by entering only the corresponding one-link index.

In particular, when an information provider is a typical personal client, who operates a personal web site, such as a personal homepage, a mini-homepage or a blog, not an individual entrepreneur, a personal identification index composed of numerals, characters or period preferred by the person, such as a mobile phone number or a resident registration number, can be registered as the one-link index, without causing a general public index according to country, area, sub-area, entrepreneur classification or business category to be registered as a one-link index.

The service provision server 200 assigns an index, selected from among a one-link index, directly input from a corresponding person or business, and various examples of a one-link index, to the person or business, and stores the assigned index in the general index DB 244 at step S28.

This embodiment is described so that the assignment of the one-link index is limited to the case where a request is received from the information provider terminal 300. However, the present invention is not limited to this embodiment, and can be constructed so that an operator performs an inspection based on predetermined criteria and assigns a one-link index regardless of the existence of the request from the information provider terminal 300.

Accordingly, a typical business is assigned a relatively long, extension-type general public index according to country, area, sub-area, entrepreneur classification or business category characteristics. However, a specific business can be assigned a one-link index, which is a short general public index capable of definitely exhibiting the characteristics of the business, regardless of country, area, sub-area, entrepreneur classification or business category characteristics. Of course, the business, assigned the short one-link index, can also be assigned a typical extension-type general public index according to the characteristic of a corresponding business, as described above, and can use both indices.

That is, when a person or a business applies a one-link index, it is preferable that both a separate one-link index, composed of numerals, characters or period, and an extension-type general public index, composed of an area index, a sub-area index, an entrepreneur classification index, a business category index and a one-link index, be used. For example, a corporation, located in Goyang city in Gyeonggi province and related to moving service, is assigned “03100A.740” as a general public index, and is assigned “2424” as a one-link index, so that the two indices can be used together. For reference, a period (.) is input before the business category index of the general public index, but it is apparent that the location of the period can be selectively changed. Further, as described above, the general public index is indicated in the form of combination of numerals, characters or period, but the configuration of an index of the present invention is not limited to the above example, and includes an index composed only of numerals.

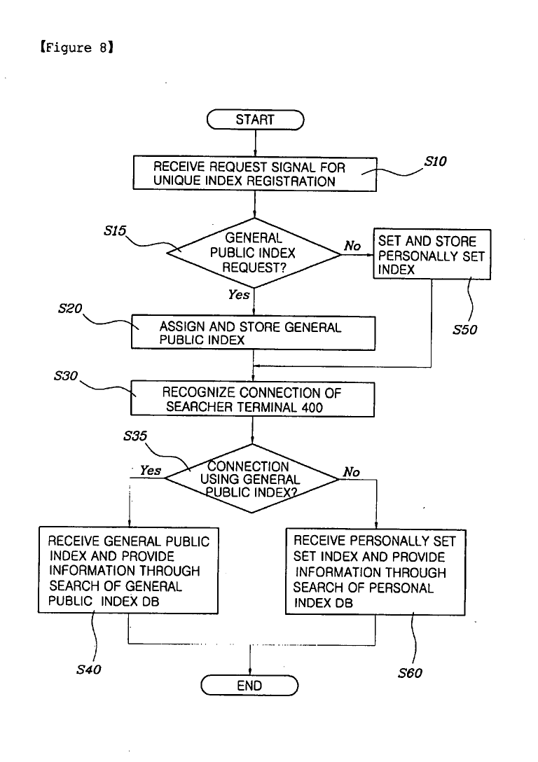

The information provision step S40 using a general public index according to the present invention is described in detail with reference to FIG. 7.

First, when the connection of the searcher terminal 400 is recognized, the service provision server 200 provides a “search screen” window, on which a general public index is displayed, to the searcher terminal 400. When the searcher enters the general public index about information of a desired person or business to be searched for through the “search screen” window, the service provision server 200 receives the general public index and stores the general public index in the memory unit 230 as a search index at step S41.

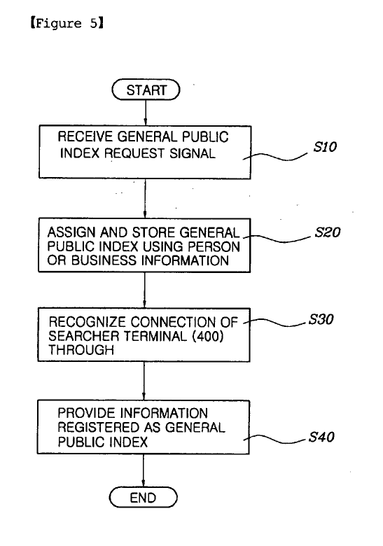

As shown in FIG. 4, the search index can be received through a URL input window (located on an upper portion of the Internet browser and indicated by “A” in FIG. 4) of the Internet browser used in the searcher terminal 400, or received through a search field provided by a site that is operated by the service provision server 200. The search field may be provided in a web page (indicated by “B” in FIG. 4), operated by the service provision server 200. Further, if a separate program provided by the service provision server 200 is downloaded and installed, a predetermined icon is generated in a window tray, so that the search field may be provided in a pop-up search window (indicated by “C” in FIG. 4) displayed when the icon is clicked.

The search index received through the URL input window or search field corresponds to any one of a country index, an area index, a sub-area index, an entrepreneur classification index and a business category index. It is apparent that, when a one-link index is registered, the search index also includes the one-link index.

It is assumed that the URL of an operator's site is “www.niss.co.kr” in this embodiment. The input format for an index is described in detail with reference to case “A” of FIG. 4.

When a searcher searches for businesses including all business categories existing in the area of Gyeonggi province, the search index input format is “www.niss.co.kr/031”. Further, when a searcher searches for businesses including all business categories existing in Goyang city in the area of Gyeonggi province, the search index input format is “www.niss.co.kr/03100”. Further, when a searcher searches for businesses that are corporations and exist in Goyang city in the area of Gyeonggi province, the search index input format is “www.niss.co.kr/03100A”, whereas when a searcher searches for a typical person, the search index input format is “www.niss.co.kr/03100C”. Further, if a searcher searches for venture businesses existing in Goyang city in the area of Gyeonggi province, the search index input format is “www.niss.co.kr/03100A.470”.

Further, if a business related to flower delivery registers “1004” as its one-link index, the search index input format necessary for searching for information about the business is “www.niss.co.kr/1004”. If a business related to transportation and moving service registers “2424” as its one-link index, the search index input format necessary for searching for information about the business is “www.niss.co.kr/2424”.

The service provision server 200 compares the search index received at step S41 with indices in the general index DB 244 at step S42, and determines whether a general public index identical to the search index exists at step S43.

As a result of the determination, if a general public index identical to the search index is found to exist, information about a person or a business, registered as the corresponding general public index, is provided to the searcher terminal 400 at step S46. The provision of information may be generally performed through a method of connecting to the homepage of a person or a business, but may be performed through a method of directly transmitting information stored in the information provider terminal 300 or the service provision server 200. Therefore, a person or a business does not necessarily need to operate a homepage.

As a result of the determination, if a general public index identical to the search index is found not to exist, a list of persons or businesses corresponding to the search index is provided to the searcher terminal 400 at step S44. The searcher checks the list of persons or businesses, selects a specific person or business to be searched for by the searcher from the list, and transmits information about the selected person or business to the service provision server 200 at step S45. The service provision server 200, having received the selected information signal, provides the information about the person or business to the searcher terminal 400 at step S46.

As a method of drawing up a list of persons or businesses corresponding to the search index, there is a method of drawing up a list of persons or businesses, registered as general public indices, each of which is the same as the search index composed of numerals, characters or period, in terms of numerals or characters in digits, other than the last digit. For example, in the case where a business related to flower delivery is registered as a one-link index of “1004”, when the searcher desires to be provided with the information about the business, but does not know an exact one-link index thereof, and enters “www.niss.co.kr/1005”, the service provision server 200 searches all general public indices, in which digit numbers other than the last digit, are equally “100*” in the search index, and provides a list of persons or businesses corresponding to the search results to the searcher terminal 400. In the list, the flower delivery-related business, registered as a general public index of “1004”, is also included. In this case, the searcher selects the desired flower delivery-related business to be searched for, so that the searcher can be provided with information about the business by the service provision server 200. As another method, a list of all persons or businesses, having the same higher portions of indices as the search index can be provided, as described above. Such methods are only embodiments, and the present invention is not limited to the embodiments.

Meanwhile, if the searcher is a mobile terminal user, and accesses the service provision server 200 through a wireless data communication network, a method of providing information using a personally set index is additionally supported, in addition to the above-described information provision method using a general public index. The information provision method using a personally set index is provided to enable more convenient searching for desired information in consideration of the construction of a keypad of a mobile terminal on which it is inconvenient to enter characters.

The personally set index is a unique index that is personally set by a mobile terminal user with respect to information about his or her favorite person or business through the service provision server 200 and is composed of numerals, characters or period, and includes a one-key index for direct connection and a one-key index for bookmarks.

The one-key index for direct connection is similar to a “shortcut number” used when a phone number is input in a mobile phone. Similar to a manner in which a call is made by pressing only the shortcut number after the shortcut number has been registered, desired information can be obtained by entering the one-key index for direct connection having a relatively small number of digits, without using a general public index, after the one-key index for direct connection has been registered. The index for bookmarks is similar to a “group” used in a mobile phone, and is constructed to collect relevant pieces of information in a single place to easily find the information later.

In order to register such a personally set index, the corresponding mobile terminal user does not necessarily need to wirelessly access a server through his or her mobile terminal, and can also be constructed to access the server through a PC, etc. over a typical wired data communication network. For this operation, the service provision server 200 can be separately operated depending on whether it is operated in a wired environment or a wireless environment.

The information provision method using the personally set index is described in detail with reference to FIGS. 8 to 10.

FIG. 8 is a flowchart showing the overall scheme in which a personally set index is included in the information provision method using a general public index of FIG. 5.

In this embodiment, steps S10, S20, S30 and S40 of the service provision server 200 receiving a request signal, required for assignment of a general public index, from the information provider terminal 300, assigning a general public index that is composed of numerals, characters or period and is preset based on the information about a person or a business, provided by the information provider terminal 300, recognizing the connection of the searcher terminal 400, and providing information about a person or a business, registered as the general public index corresponding to a search index input from the searcher terminal 400, to the searcher terminal 400, are the same as the above embodiment.

Further, at step S20 of assigning the general public index, steps S21, S22, S23, S24, S25, S26 and S27 of assigning a country index, an area index, a sub-area index, an entrepreneur classification index, a business category index and a one-link index that are each composed of numerals, characters or period and are each preset based on the person or business information provided by the information provider terminal 300, and steps S41, S42, S43, S44, S45 and S46 of providing information about a person or a business, set in connection with the general public index corresponding to a search index input from the searcher terminal 400, to the searcher terminal 400, are the same as the above embodiment. However, if the searcher terminal 400 is a mobile terminal, a URL input window may not exist in the Internet browser, used in the searcher terminal 400, so that step S42 is constructed to input a search index to the search field provided by the service provision server 200.

In this embodiment, when the searcher terminal 400 is a mobile terminal, connection to the service provision server 200 may be required to conduct a search using a personally set index, as well as a search using a general public index. In this case, in order to perform the search using the personally set index, the step of the searcher terminal 400 requesting a personally set index from the service provision server 200 and registering the personally set index must be executed before the search.

Therefore, when receiving a request signal for the registration of a unique index, the service provision server 200 must determine whether the request signal is a signal from the information provider terminal 300 to register a general public index, or a signal from the searcher terminal 400 to register a personally set index at step S15. As a result of the determination, if the request signal is found to be a signal from the information provider terminal 300 to register a general public index, step S20 is performed, whereas if the request signal is found to be a signal from the searcher terminal 400 to register a personally set index, a personally set index composed of numerals, characters or period preferred by the corresponding searcher, is registered and is stored in the personal index DB 246 at step S50.

Thereafter, when the service provision server 200 recognizes the connection of the searcher terminal 400, the service provision server determines whether the connection corresponds to a search using a general public index or a search using a personally set index at step S35. As a result of the determination, if the connection is found to correspond to a search using a general public index, step S40 is performed, whereas if the connection is found to correspond to a search using a personally set index, personally set indices, prestored in the personal index DB 246, are searched, and information about a person or a business, which is set in connection with a personally set index corresponding to the input search index, is provided to the searcher terminal 400 at step S60.

A procedure of registering a personally set index at step S50 according to the present invention is described in detail with reference to FIG. 9.

When receiving a request signal for a personally set index from the searcher terminal 400, the service provision server 200 requests information about a desired person or business to which to be directly connected (for example a URL), and receives the information from the searcher terminal 400 at step S51. Thereafter, the service provision server 200 requests a one-key index for direct connection to information about a corresponding person or business, receives the one-key index, and stores the one-key index in the personal index DB 246 at step S52. The reception of the information about the person or business and the reception of the one-key index for direct connection to the information can be simultaneously performed.

The service provision server 200 asks the searcher terminal 400 whether to add a one-key index for direct connection, and determines whether to add the one-key index at step S53. As a result of the determination, if the searcher is found to desire the addition of the one-key index for direct connection, steps S51 and S52 are repeated, whereas if the searcher is not found to desire the addition of the one-key index, the service provision server 200 requests information about a desired person or business to be set as a personal bookmark from the searcher terminal 400, and receives the information from the searcher terminal 400 at step S54. Thereafter, the service provision server 200 displays a one-key index for bookmarks that allows the searcher to directly access the personal bookmark, and registers the person or business information, received at step S54, as the personal bookmark of the corresponding searcher at step S55. The service provision server 200 asks the searcher terminal 400 whether to add a one-key index for bookmarks and determines whether to add the one-key index at step S56. As a result of the determination, if the searcher is found to desire the addition of the one-key index for bookmarks, steps S54 and S55 are repeated.

In this embodiment, it is desirable that steps S51 and S52 of registering the one-key index for the direct connection and steps S54 and S55 of registering the one-key index for the bookmarks be sequentially performed, but it is apparent that these functions can be constructed as separate menu items and be performed simultaneously.

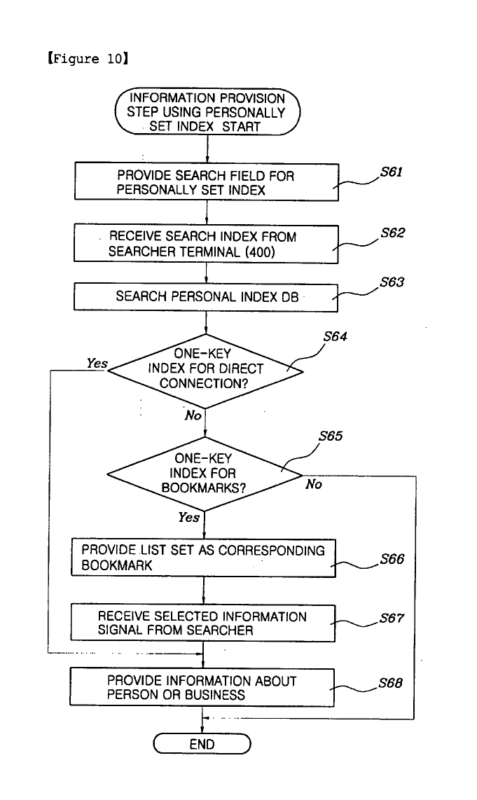

The information provision procedure using a personally set index at step S60 according to the present invention is described in detail with reference to FIG. 10.

When recognizing the connection of the searcher terminal 400, the service provision server 200 provides a “search screen” window, including a search field for inputting a personally set index, to the searcher terminal 400 at step S61. If the searcher inputs a personally set index, preset by the searcher in connection with information about a person or a business to be searched for, to the search field, the service provision server 200 receives the personally set index and stores the personally set index in the memory unit 230 as a search index at step S62.

The search index received at step S62 is compared with indices in the personal index DB 260 at step S63, and whether the search index is a one-key index for direct connection is determined at step S64. As a result of the determination, if the search index is found to be a one-key index for direct connection, information about a person or a business corresponding to the one-key index is provided to the searcher terminal 400 at step S68.

If the search index is found not to be a one-key index for direct connection, whether the search index is a one-key index for bookmarks is determined at step S65. If the search index is found to be a one-key index for bookmarks, a list of persons or businesses, set as a corresponding personal bookmark, is provided to the searcher terminal 400 at step S66. The searcher checks the list of persons or businesses, selects a specific person or business to be searched for from the list, and transmits information about the selected person or business to the service provision server 200 at step S67. The service provision server 200, having received the selected information signal, provides the information about the person or business to the searcher terminal 400 at step S68.

Finally, a method of determining whether access corresponds to connection to a general public index or connection to a personally set index when the searcher terminal 400 accesses the service provision server 200 in order to conduct a search is described. For this operation, the keypad of a mobile terminal is preferably provided with a separate hotkey (HK), as shown in FIG. 3.

First, there is a method of separately providing a hotkey for connection to a general public index and a hotkey for connection to a personally set index on the searcher terminal 400, so that the service provision server 200 receives different access signals, thus performing the determination.

As another method, there is a method of providing a single hotkey on the searcher terminal 400, inputting a specific number code specifying a connection purpose, and pressing the hotkey, so that different access signals for input number codes are transmitted to the service provision server 200, thus determining whether the access corresponds to connection to the general public index or to connection to the personally set index.

As a further method, there is a method of providing a single hotkey on the searcher terminal 400 and varying the number of times that the searcher presses the hotkey, so that different access signals are transmitted to the service provision server 200, thus determining whether the access corresponds to connection to a general public index or connection to a personally set index.

As still another method, there is a method of providing a single hotkey on the searcher terminal 400 and forcing selection of a menu item for each separate connection purpose after the hotkey on the searcher terminal 400 is pressed to access the service provision server 200, thus determining whether the access corresponds to connection to a general public index or to connection to a personally set index.

As still another method, there is a method of providing a separate service menu item for accessing the service provision server 200, instead of providing a separate hotkey on the searcher terminal 400, and allowing a searcher to always select only the corresponding menu item, access the service provision server 200 and forcing selection of a separate menu item for each connection purpose, thus determining whether the access by the searcher terminal 400 corresponds to connection to a general public index or to connection to a personally set index.

As still another method, there is a method of registering the service provision server 200 as a content provider (CP) in a wireless Internet menu item provided by the communication service provider of a corresponding mobile terminal, instead of providing a separate hotkey on the searcher terminal 400, and separately providing a general public index menu item and a personally set index menu item, thus determining whether the access by the searcher terminal 400 corresponds to connection to a general public index or to connection to a personally set index.

In this embodiment, the case where a searcher, who is a mobile terminal user, inputs a desired general public index or personally set index to a search field provided by the service provision server 200 and is provided with information about a person or a business corresponding to the search index, is described. However, the present invention is not limited to this embodiment, but may be constructed so that a separate service code, indicating the service provision server 200, has been previously input to an actual search field to classify a service provider, so that a searcher inputs a suitable search index subsequent to the service code of the service provision server 200, thus enabling connection to a general public index or a personally set index.

### INDUSTRIAL APPLICABILITY

As described above, the present invention provides an information provision method using a data communication network, which provides a general public index composed of numerals, characters or period based on personal or business information, and a personally set index composed of numerals, characters or period preferred by a searcher, thus enabling the searcher to more conveniently, easily and rapidly access desired information. Further, since the general public index and the personally set index can be easily input to a mobile terminal, as well as a wired terminal, an integrated search system can be constructed. Moreover, an information provider can provide desired information using the index search system of the present invention, without requiring a web site therefor.

1. A method of providing information using a data communication network, comprising the steps of:
(a) a service provision server (200) receiving a unique index request signal, wherein the service provision server is required to register a unique general public index for information about a person or a business, from an information provider terminal (300);
(b) the service provision server (200) assigning a general public index composed of numerals, characters or period, based on information about the corresponding person or business when receiving the unique index request signal from the information provider terminal (300), and storing the general public index;
(c) the service provision server (200) recognizing a connection of a searcher terminal (400) through a wired or wireless data communication network (100); and
(d) the service provision server (200) receiving a search index input from the searcher terminal (400), searching previously stored general public indices, and providing information about the person or the business, registered as a general public index corresponding to the search index, to the searcher terminal (400).

2. The information provision method according to claim 1, wherein step (b) comprises the steps of:
(b-1) the service provision server (200) requesting information, to which an index is to be assigned, from the information provider terminal (300), having requested registration of the general public index, and storing the requested information in a member information DB (242);
(b-2) the service provision server (200) assigning an area index that is composed of numerals, characters or period and is preset based on the stored information, and storing the area index in a general index DB (244);
(b-3) the service provision server (200) assigning a sub-area index that is composed of numerals, characters or period and is preset based on the stored information, and storing the sub-area index in the general index DB (244);
(b-4) the service provision server (200) assigning an entrepreneur classification index that is composed of numerals, characters or period and is preset based on the stored information, and storing the entrepreneur classification index in the general index DB (244); and
(b-5) the service provision server (200) assigning to the corresponding business or person a business category index that is composed of numerals, characters or period and is preset based on the stored information, and storing the business category index in the general index DB (244);
wherein the search index is the information received through a URL input window of an Internet browser used in the searcher terminal (400), or through a search field provided by a site operated by the service provision server (200), and includes at least one of the area index, the sub-area index, the entrepreneur classification index, and the business category index.

3. The information provision method according to claim 2, wherein step (b) further comprises the steps of:
(b-6) the service provision server (200) determining whether a request for registration of a one-link index has been received from the corresponding information provider terminal (300); and
(b-7) if a request for registration of a one-link index has been received, the service provision server (200) assigning a one-link index composed of numerals, characters or period, and storing the one-link index in the general public index DB;
wherein the search index includes at least one of the area index, the sub-area index, the entrepreneur classification index, the business category index, and the one-link index.

4. The information provision method according to claim 3, wherein step (b) further comprises, before step (b-2), the step of the service provision server (200) assigning a country index that is composed of numerals, characters or period and is preset based on the stored information, and storing the country index in the general index DB (244);
wherein the search index includes at least one of the country index, the area index, the sub-area index, the entrepreneur classification index, the business category index, and the one-link index.

5. The information provision method according to claim 2, wherein step (d) comprises the steps of:
(d-1) if, as a result of the search of the general index DB (244) by the service provision server (200), it is determined that a general public index identical to the search index exists, providing the information about a person or a business, registered as the corresponding general public index, to the searcher terminal (400); and
(d-2) if, as a result of the search of the general index DB (244) by the service provision server (200), it is determined that no general public index identical to the search index exists, providing a list of persons or businesses corresponding to the search index to the searcher terminal (400), and then providing information about the person or the business, selected by a searcher from the list, to the searcher terminal (400).

6. The information provision method according to claim 1, wherein, if the searcher terminal (400) is a mobile terminal, step (b) comprises the steps of:
(b-1) the service provision server (200) requesting information to which an index is to be assigned from the information provider terminal (300), having requested registration of the general public index, and storing requested information in a member information DB (242);
(b-2) the service provision server (200) assigning an area index that is composed of numerals, characters or period and is preset based on the stored information, and storing the area index in a general index DB (244);
(b-3) the service provision server (200) assigning a sub-area index that is composed of numerals, characters or period and is preset based on the stored information, and storing the sub-area index in the general index DB (244);
(b-4) the service provision server (200) assigning an entrepreneur classification index that is composed of numerals, characters or period and is preset based on the stored information, and storing the entrepreneur classification index in the general index DB (244); and
(b-5) the service provision server (200) assigning to the corresponding business or person a business category index that is composed of numerals, characters or period and is preset based on the stored information, and storing the business category index in the general index DB (244).

7. The information provision method according to claim 6, wherein step (b) further comprises the steps of:
(b-6) the service provision server (200) determining whether a request for registration of a one-link index has been received from the corresponding information provider terminal (300); and
(b-7) if a request for registration of a one-link index has been received, the service provision server (200) assigning a one-link index composed of numerals, characters or period, and storing the one-link index in the general public index DB;
wherein the search index includes at least one of the area index, the sub-area index, the entrepreneur classification index, the business category index and the one-link index.

8. The information provision method according to claim 7, wherein step (b) further comprises, before step (b-2), the step of the service provision server (200) assigning a country index that is composed of numerals, characters or period and is preset based on the stored information, and storing the country index in the general index DB (244);
wherein the search index includes at least one of the country index, the area index, the sub-area index, the entrepreneur classification index, the business category index, and the one-link index.

9. The information provision method according to claim 1, wherein, in order for a searcher to access the service provision server (200) through a personally set index using a mobile terminal,
step (c) comprises the step of (c-1) the service provision server (200) receiving a unique index request signal, which is required to register a personally set index for the searcher terminal (400), from the searcher terminal (400), registering a personally set index composed of numerals, characters or period for the information about a person or a business, which is preferred by a corresponding searcher, and storing the personally set index; and
step (d) comprises the step (d-1) of, if the search index is a personally set index, the service provision server (200) searching previously stored personally set indices, and providing the information about the person or the business, registered as a personally set index corresponding to the search index, to the searcher terminal (400).

10. The information provision method according to claim 9, wherein the personally set index includes a one-key index for direct connection and a one-key index for bookmarks, and step (c-1) comprises, in order to set respective one-key indices, the steps of:
(c-1-1) the service provision server (200) requesting information about a desired person or business to which to be directly connected from the searcher terminal (400), having requested the personally set index, and receiving at least one piece of information from the searcher terminal (400);
(c-1-2) the service provision server (200) requesting the one-key index for direct connection, composed of numerals, characters or period, to the information about the desired person or business to which to be directly connected, setting the information about the person or business in connection with the received one-key index for direct connection, and storing the one-key index in a personal index DB (246);
(c-1-3) the service provision server (200) requesting information about a desired person or business to be set as a personal bookmark from the searcher terminal (400), having requested the personally set index, and receiving at least one piece of the information from the searcher terminal (400); and
(c-1-4) the service provision server (200) displaying the one-link index for bookmarks, composed of numerals, characters or period, to directly access the personal bookmark, setting information about a desired person or business to a personal bookmark of the corresponding searcher terminal (400), and storing the personal bookmark in the personal index DB (246).

11. The information provision method according to claim 10, wherein step (d-1) comprises the steps of:
(d-1-1) the service provision server (200) providing a search field to the searcher terminal (400) that is accessed for connection to the personally set index, and receiving an input search index;
(d-1-2) the service provision server (200) searching the personal index DB (246) using the received search index;
(d-1-3) if, as a result of the search of the personal index DB (246) by the service provision server (200), the search index is a preset one-key index for direct connection, providing information about a person or a business, set in connection with the one-key index, to the searcher terminal (400); and
(d-1-4) if, as a result of the search of the personal index DB (246) by the service provision server (200), the search index is a one-key index for bookmarks, providing a list of information about persons or businesses, set as a corresponding bookmark, to the searcher terminal (400) and providing information about a person or a business selected by the searcher to the searcher terminal (400).

12. The information provision method according to claim 9, wherein, in order for the service provision server (200) to determine whether access by the searcher terminal (400) corresponds to the connection to a general public index, or to the connection to a personally set index at step (c), a method is selected from a group consisting of:
a method of separately providing a hotkey for the connection to the general public index and a hotkey for the connection to the personally set index on the searcher terminal (400), and allowing the service provision server (200) to receive different access signals for respective hotkeys, thus performing determination;
a method of providing a single hotkey on the searcher terminal (400), pressing the hotkey after entering a number code specified according to connection purpose, and allowing the service provision server (200) to receive different access signals for respective input number codes, thus performing determination;
a method of providing a single hotkey on the searcher terminal (400), varying the number of times that a searcher presses the hotkey depending on connection purpose, and allowing the service provision server (200) to receive different access signals depending on the number of pressing times, thus performing determination;
a method of providing a single hotkey on the searcher terminal (400) and forcing selection of a menu item for each connection purpose after the searcher terminal (400) has accessed the service provision server (200), thus performing determination;
a method of providing a separate service menu item for accessing the service provision server (200), instead of providing a separate hotkey on the searcher terminal (400), and forcing selection of a separate menu item for each connection purpose after the searcher terminal (400) has accessed the service provision server (200), thus performing determination; and
a method of registering a wireless Content Provider (CP) menu item for accessing the service provision server (200) as a lower level menu item on the wireless Internet of a service provider, to which the corresponding searcher terminal (400) belongs, instead of providing a separate hotkey on the searcher terminal (400), and forcing selection of a separate menu item for each connection purpose after the searcher terminal (400) has accessed the service provision server (200), thus performing determination.

13. The information provision method according to claim 3, wherein step (d) comprises the steps of:
(d-1) if, as a result of the search of the general index DB (244) by the service provision server (200), it is determined that a general public index identical to the search index exists, providing the information about a person or a business, registered as the corresponding general public index, to the searcher terminal (400); and
(d-2) if, as a result of the search of the general index DB (244) by the service provision server (200), it is determined that no general public index identical to the search index exists, providing a list of persons or businesses corresponding to the search index to the searcher terminal (400), and then providing information about the person or the business, selected by a searcher from the list, to the searcher terminal (400).

14. The information provision method according to claim 4, wherein step (d) comprises the steps of:
(d-1) if, as a result of the search of the general index DB (244) by the service provision server (200), it is determined that a general public index identical to the search index exists, providing the information about a person or a business, registered as the corresponding general public index, to the searcher terminal (400); and
(d-2) if, as a result of the search of the general index DB (244) by the service provision server (200), it is determined that no general public index identical to the search index exists, providing a list of persons or businesses corresponding to the search index to the searcher terminal (400), and then providing information about the person or the business, selected by a searcher from the list, to the searcher terminal (400).

15. The information provision method according to claim 6, wherein, in order for a searcher to access the service provision server (200) through a personally set index using a mobile terminal,
step (c) comprises the step of (c-1) the service provision server (200) receiving a unique index request signal, which is required to register a personally set index for the searcher terminal (400), from the searcher terminal (400), registering a personally set index composed of numerals, characters or period for the information about a person or a business, which is preferred by a corresponding searcher, and storing the personally set index; and
step (d) comprises the step (d-1) of, if the search index is a personally set index, the service provision server (200) searching previously stored personally set indices, and providing the information about the person or the business, registered as a personally set index corresponding to the search index, to the searcher terminal (400).

16. The information provision method according to claim 7, wherein, in order for a searcher to access the service provision server (200) through a personally set index using a mobile terminal,
step (c) comprises the step of (c-1) the service provision server (200) receiving a unique index request signal, which is required to register a personally set index for the searcher terminal (400), from the searcher terminal (400), registering a personally set index composed of numerals, characters or period for the information about a person or a business, which is preferred by a corresponding searcher, and storing the personally set index; and
step (d) comprises the step (d-1) of, if the search index is a personally set index, the service provision server (200) searching previously stored personally set indices, and providing the information about the person or the business, registered as a personally set index corresponding to the search index, to the searcher terminal (400).

17. The information provision method according to claim 8, wherein, in order for a searcher to access the service provision server (200) through a personally set index using a mobile terminal,
step (c) comprises the step of (c-1) the service provision server (200) receiving a unique index request signal, which is required to register a personally set index for the searcher terminal (400), from the searcher terminal (400), registering a personally set index composed of numerals, characters or period for the information about a person or a business, which is preferred by a corresponding searcher, and storing the personally set index; and
step (d) comprises the step (d-1) of, if the search index is a personally set index, the service provision server (200) searching previously stored personally set indices, and providing the information about the person or the business, registered as a personally set index corresponding to the search index, to the searcher terminal (400).
